(19) United States
(12) Patent Application Publication
(10) Pub. No.: US 2009/0310886 A1
(43) Pub. Date: Dec. 17, 2009

(54) Device and method for correcting for uneven exposure, and computer-readable recording medium containing program

(75) Inventor: Yoshiro Kitamura, Kanagawa-ken (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/457,575

(22) Filed: Jun. 16, 2009

(30) Foreign Application Priority Data
Jun. 17, 2008 (JP) 157789/2008

(51) Int. Cl. G06K 9/40

(52) U.S. Cl. 382/275

(57) ABSTRACT

A direct X-ray region extracting means extracts a direct X-ray region, which is at least a portion of a region without the subject contained therein, from an X-ray image formed by an X-ray applied from an X-ray tube to a subject; an uneven exposure component estimating means estimates an uneven exposure component at individual pixels of the X-ray image based on a relationship between positions and pixel values of at least some of pixels in the direct X-ray region; and an uneven exposure correcting means removes the estimated uneven exposure component from the X-ray image.

### BACKGROUND OF THE INVENTION

1. Field of the Invention

The present invention relates to a device and a method for correcting for uneven exposure in X-ray images, and a computer-readable recording medium containing a program for causing a computer to carry out the method.

2. Description of the Related Art

Imaging diagnosis systems are known, which includes: an X-ray imaging device that records image information, which is formed by exposing a subject to radiation, on a storage phosphor sheet (IP) including a sheet-like storage phosphor layer; and an image reading device that generates digital image data by scanning the storage phosphor sheet with excitation light, such as laser light, to induce photostimulated luminescence and photoelectrically reading the obtained photostimulated luminescence to obtain an analog image signal, and then digitalizing the analog image signal.

Radiographic images obtained by such a system may contain uneven exposure component, which is generated due to radiation distribution of a radiation source used, scattered radiation, etc., and noise component, which is generated due to uneven sensitivity of the individual pixels of a line sensor used to detect the photostimulated luminescence on the storage phosphor sheet.

In order to appropriately minimize the uneven exposure component and the noise component in the radiographic images according to conditions, such as type of the imaging device, imaged part, imaging environment, etc., a device has been proposed, which stores radiation dose distribution of radiation emitted from the radiation source and sensitivity distribution of the photoelectric conversion device, such as a line sensor, and corrects the radiographic image data, using only the sensitivity distribution or both the sensitivity distribution and the radiation distribution depending on the above-described conditions. The radiation distribution herein is generated from a reference image, which is obtained through imaging without a subject and represents only the uneven exposure component. Further, it has been proposed that, in this device, more than one radiation distributions depending on imaging environments are stored, and an appropriate one of the stored radiation distributions is selected to be used for the correction depending on the imaging environment of the radiographic image, and that the radiographic image is corrected after the radiation distribution has been modified according to the imaging conditions.

Further, for mammographic imaging which images the breast as a subject, it has been disclosed that radiation having a radiation distribution where the radiation dose is higher at the chest wall side than at the nipple side is applied, and the obtained image is corrected using only the sensitivity distribution, not using the radiation distribution (see, for example, Japanese Unexamined Patent Publication No. 2006-267427).

On the other hand, when diagnosis is carried out with displaying a mammographic image (such as “P_{org}” shown in FIG. 10) on a display device, the gray level of the image or the density level of the image is often changed or inverted. However, when the gray level is inverted, the color of a direct X-ray region, which contains no subject, is changed to white, and this is said to be too bright to the eye and hinder the diagnosis (see, for example, “Pᵣₑᵥ” shown in FIG. 16).

In order to address this problem, it is considered to mask the direct X-ray region using a Pixel Padding Value, which is a part of associated information based on the DICOM standard. Specifically, as the Pixel Padding Value, a threshold for discriminating the direct X-ray region from other regions is set. When an image is displayed on an image viewer complying to the DICOM standard with the density level of the image being inverted, the direct X-ray region is masked using the Pixel Padding Value to provide glare prevention.

However, since X-ray images contain the uneven exposure component, as described above, the entire direct X-ray region may not correctly be specified with a simple threshold such as the Pixel Padding Value. For example, an image P_{bs} shown in FIG. 12 is an image obtained by applying density conversion to the original image P_{org} shown in FIG. 10 and then enhancing the uneven exposure component of the background. If the original image P_{org} contains the uneven exposure component as shown in the image P_{bs}, and a mask image is generated by applying the simple thresholding using the Pixel Padding Value to the original image P_{org}, a portion of the direct X-ray region which has low radiation dose due to the uneven exposure (in the vicinity of the upper end portion of an image Pₘₛₖ) is outside the mask region (the black area of the image Pₘₛₖ), as in the image Pₘₛₖ shown in FIG. 11. Therefore, if the density-inverted image Pᵣₑᵥ is masked with the mask image Pₘₛₖ, as shown in FIG. 16, an image, such as an image Pᵣₘₗ, is provided which has incomplete glare prevention provided by the mask at the direct X-ray region. Further, if the Pixel Padding Value is set to widely extract the direct X-ray region, the subject region is also masked and an image which is not suitable for diagnosis is provided.

In such a case, if the above-mentioned device disclosed in Japanese Unexamined Patent Publication No. 2006-267427 is used, the uneven exposure component can be minimized by using the radiation distribution stored in advance. However, storing the radiation distributions corresponding to various factors influencing the uneven exposure component, such as difference among radiation sources and fluctuation of tube voltage, and carrying out the correction after modifying the radiation distribution which has been obtained under conditions different from the conditions under which the radiographic image to be corrected has been imaged may lead to complication of the system. In addition, as described above, in the above-mentioned Japanese Unexamined Patent Publication No. 2006-267427, only the sensitivity distribution is used for the correction and the radiation distribution is not used in the case of mammographic imaging. Therefore, there is no mention of minimizing the uneven exposure component in mammographic imaging.

### SUMMARY OF THE INVENTION

In view of the above-described circumstances, the present invention is directed to providing a device and a method for correcting for uneven exposure, which allow minimization of uneven exposure component in X-ray images in an appropriate manner for each image, and a computer-readable recording medium containing a program for causing a computer to carry out the method.

An aspect of the device for correcting for uneven exposure of the invention includes: direct X-ray region extracting means for extracting a direct X-ray region from an X-ray image formed by an X-ray applied from an X-ray tube to a subject, the direct X-ray region being at least a portion of a region without the subject contained therein; uneven exposure component estimating means for estimating an uneven exposure component at individual pixels of the X-ray image based on a relationship between positions and pixel values of at least some of pixels in the direct X-ray region; and uneven exposure correcting means for removing the uneven exposure component from at least the region without the subject contained therein of the X-ray image.

An aspect of the method for correcting for uneven exposure includes the steps of: extracting a direct X-ray region from an X-ray image formed by an X-ray applied from an X-ray tube to a subject, the direct X-ray region being at least a portion of a region without the subject contained therein; estimating an uneven exposure component at individual pixels of the X-ray image based on a relationship between positions and pixel values of at least some of pixels in the direct X-ray region; and removing the uneven exposure component from at least the region without the subject contained therein of the X-ray image.

The computer-readable recording medium containing a program for correcting for uneven exposure of the invention causes a computer to carry out the above-described method for correcting for uneven exposure.

Now, details of the invention are described.

The “subject” herein may be one that requires detection of a small difference in density of an image during image interpretation. A specific example thereof is the breast of a human body.

The “direct X-ray region” herein may be all or a part of the region without the subject contained therein of the original X-ray image.

A specific example of a technique used to extract the direct X-ray region may include extracting a region in the original X-ray image having an exposure dose that is larger than a value obtained by a predetermined method. A specific example of the “predetermined method” herein may include rearranging all the pixels of the original X-ray image in the order of exposure dose (image density) and finding (a pixel value corresponding to) an exposure dose of a pixel which is at a position corresponding to a predetermined percent of the total number of pixels from the pixel having the maximum dose (i.e., the pixel having the smallest dose among the pixels contained in the predetermined percent of pixels).

The “estimating an uneven exposure component at individual pixels of the X-ray image based on a relationship between positions and pixel values of at least some of pixels in the direct X-ray region” herein refers to estimating the uneven exposure component at individual pixels not only in the direct X-ray region but also in the entire original X-ray image based on the pixel value distribution in the entire direct X-ray region. The “pixel value distribution in the entire direct X-ray region” may not necessary be a distribution of all the pixels in the direct X-ray region, and may be a pixel value distribution of some pixels in the direct X-ray region, as long as it can provide the pixel value distribution in not a local portion but the entire portion of the direct X-ray region. As a specific example, a pixel value distribution of pixels in the direct X-ray region in a direction on the X-ray image (hereinafter referred to as a tube axial direction of the X-ray image) corresponding to a direction connecting an anode and a cathode of the X-ray tube (hereinafter referred to as a tube axial direction of the X-ray tube) may be detected, and the uneven exposure component at individual pixels of the X-ray image in the tube axial direction on the X-ray image maybe estimated based on the detected pixel value distribution. In this manner, the uneven exposure component, which is not uniform in the tube axial direction on the X-ray image and is uniform in the direction perpendicular to the tube axial direction on the X-ray image, can be estimated.

A specific example of the uneven exposure component is an uneven exposure component induced by the heel effect of X-ray. The heel effect of X-ray is a phenomenon where the X-ray is absorbed by a substance forming the anode of the X-ray tube, resulting in that the X-ray applied to the cathode side has higher dose and lower energy than the X-ray applied to the anode side. The heel effect is markedly observed with a low energy X-ray used in mammographic imaging.

For determining the tube axial direction on the X-ray image, it may be considered to store a relationship between imaging directions (such as MLO and CC) of the subject and the tube axial direction on the X-ray image, and to determine such that the shorter side direction of the image corresponds to the tube axial direction of the X-ray tube, i.e., is the tube axial direction on the X-ray image, based on imaging direction information obtained from the associated information of the X-ray image to be processed.

A specific method for achieving the “estimation of the uneven exposure component” may include, for example, approximating a two-dimensional pixel value distribution in the entire direct X-ray region with a function that represents a curved surface in a coordinate space with plotting the pixel values along the z-axis and plotting two-dimensional positions of the pixels along x- and y-axes, or approximating a pixel value distribution of pixels in the direct X-ray region in the tube axial direction on the X-ray image with a function expressed as a multinomial. The applicant has found that, for estimating the uneven exposure component due to the heel effect of X-ray, a quadratic function may preferably be used as the function expressed as a multinomial. An example of a technique usable for approximation to a function is the least square method.

The uneven exposure component may be removed from the entire X-ray image or from the region without the subject contained therein of the X-ray image.

### BRIEF DESCRIPTION OF THE DRAWINGS

FIG. 1 is a diagram illustrating the schematic configuration of an X-ray image reading system,

FIG. 2 is a diagram illustrating the schematic configuration of an X-ray imaging device (breast imaging device),

FIG. 3 is a diagram illustrating the schematic configuration of an X-ray source,

FIG. 4 is a diagram for explaining heel effect,

FIG. 5 illustrates one example of an image reading device,

FIG. 6 is a perspective view of an image reading section,

FIG. 7 is a diagram for explaining a relationship between a mammographic image and the heel effect,

FIG. 8 is a diagram illustrating the schematic configuration of an uneven exposure correcting unit (a device for correcting for uneven exposure),

FIG. 9 illustrates one example of frequency of appearance of pixel values in a mammographic image,

FIG. 10 illustrates one example of an original mammographic image,

FIG. 11 illustrates a binarized image of the original mammographic image,

FIG. 12 illustrates an image having improved gradation of a direct X-ray region of the original mammographic image,

FIGS. 13A-13D are diagrams for explaining a method for correcting the mammographic image,

FIG. 14 is a flow chart for explaining the flow of a process carried out in the X-ray image reading system,

FIG. 15 illustrates one example of a density-inverted mammographic image with an appropriately masked direct X-ray region, and

FIG. 16 illustrates one example of a density-inverted image of the original mammographic image and one example a density-inverted image with an inappropriately masked direct X-ray region.

### DESCRIPTION OF THE PREFERRED EMBODIMENTS

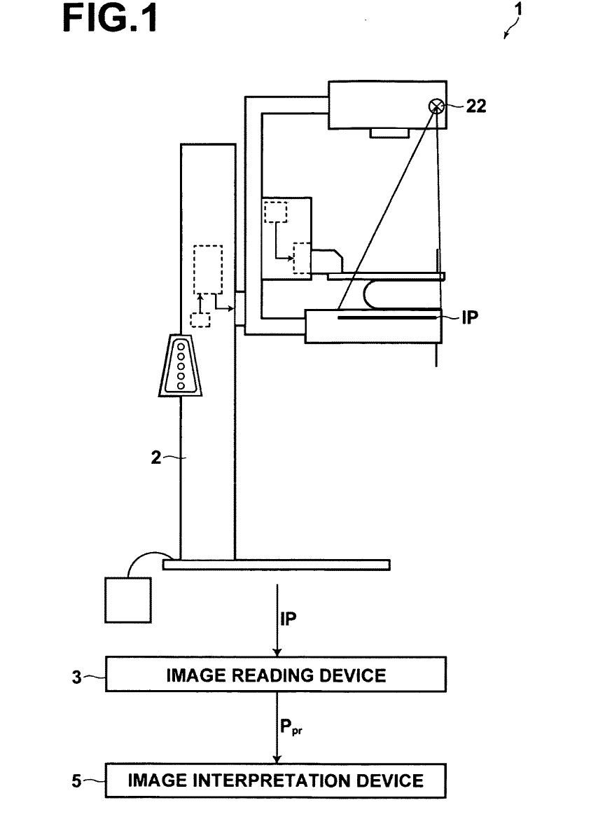

Hereinafter, an embodiment of a device for correcting for uneven exposure of the present invention will be described with reference to the drawings. FIG. 1 illustrates one example of an X-ray image reading system which employs the device for correcting for uneven exposure of the invention. As shown in FIG. 1, the X-ray image reading system 1 includes: an X-ray imaging device 2, which applies X-ray from an X-ray source 22 onto a subject and causes a storage phosphor sheet IP to detect the X-ray transmitted through the subject and record X-ray image information; an image reading device 3, which reads an X-ray image from the storage phosphor sheet IP on which the X-ray image information is recorded; and an image interpretation device 5, which displays the X-ray image.

In this embodiment, a case where the image reading device 3 has a function of the device for correcting for uneven exposure of the invention is described. Further, this embodiment is described specifically about a case where the breast is imaged as the subject, and the X-ray imaging device 2 is a breast imaging device for imaging the breast.

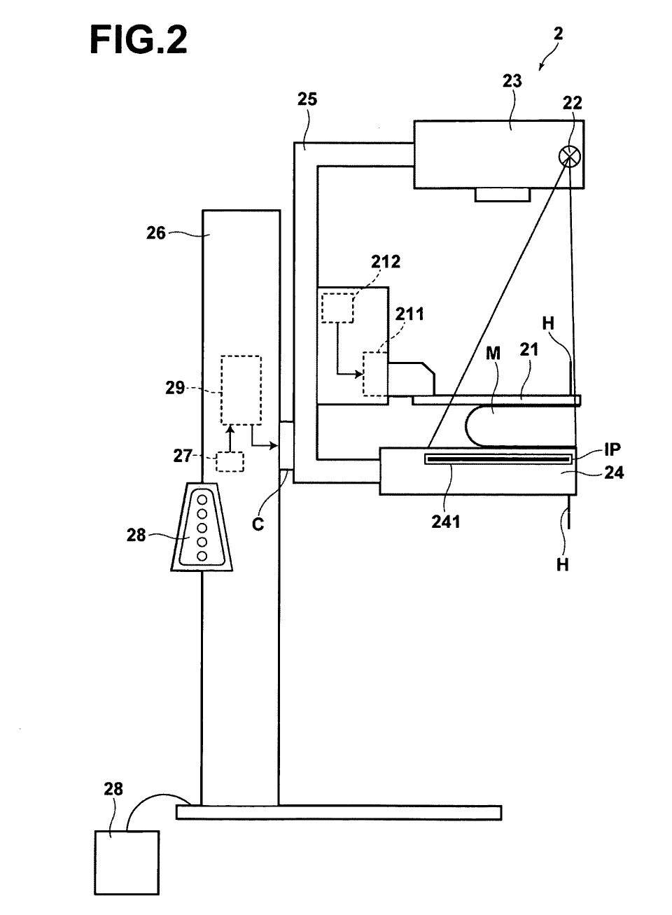

FIG. 2 is a schematic diagram illustrating the breast imaging device 2 according to the invention.

The breast imaging device 2 includes a radiation source housing 23, which contains the X-ray irradiation unit 22, an arm 25, which couples the X-ray irradiation unit 22 with an imaging stage 24 such that they face each other, a base 26 that supports the arm 25 via a shaft C, and an imaging control unit 27.

The imaging control unit 27 includes a CPU and memories, such as a ROM storing a controlling program and a RAM, and controls the various mechanisms, such as rotation of the arm 25 and X-ray emission from the X-ray irradiation unit 22.

The base 26 includes an imaging manipulation unit 28, which allows the operator to adjust height, rotation amount and direction of the arm 25, and an arm moving unit 29, which effects vertical movement and rotational movement of the arm 25. Input from the imaging manipulation unit 28 is sent to the imaging control unit 27, and a movement instruction signal according to the input is transmitted from the imaging control unit 27 to the arm moving unit 29.

The arm 25 includes, between the X-ray irradiation unit 22 and the imaging stage 24, an attaching section 211, at which a pressing plate 21 is attached for pressing the breast M from above onto the imaging stage 24, and a pressing plate moving unit 212, which moves the attaching section 211 along the longitudinal direction of the arm 25.

An image detector is placed inside the imaging stage 24. The image detector includes a cassette (recording medium holding section) 241 containing a recording medium, such as a storage phosphor sheet (hereinafter referred to as an imaging plate) IP, on which the image information is to be recorded.

The arm 25 is attached to the base 26 via the shaft C such that the rotation center of the arm 25 is positioned substantially at the center of the image detector.

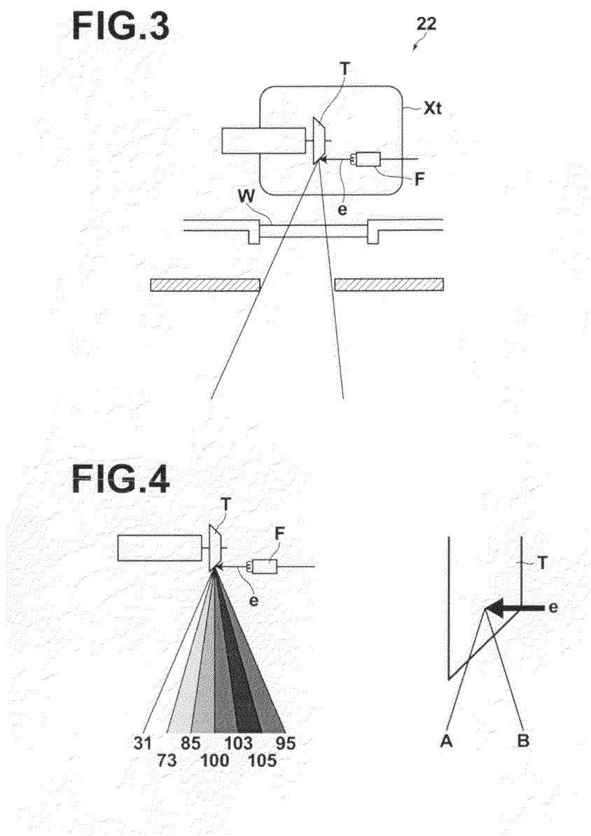

As shown in FIG. 3, the X-ray irradiation unit 22 includes an X-ray tube Xt, which emits an X-ray, and a radiation window W, through which the X-ray emitted from the X-ray tube Xt is transmitted. When a mammographic image P_{org} is imaged, the X-ray tube Xt is positioned immediately above the end of the imaging stage 24 at the chest wall H side so that the emitted X-ray sufficiently irradiates the breast M placed on the imaging stage 24 to the area in the vicinity of the chest wall H.

The X-ray tube Xt includes therein a filament (cathode) F and a metal target (anode) T. The X-ray is emitted by heating the filament F to a high temperature to generate thermal electrons E and accelerating the thermal electrons E at a high voltage of 10-300 keV to have the thermal electrons E collide against the metal target T. The energy spectrum of the X-ray emitted from the X-ray tube Xt is a mixture of a continuous spectrum (continuous X-ray), which is generated by bremsstrahlung radiation with the maximum energy being the acceleration energy of the electrons E, and a line spectrum, which is also called characteristic X-ray, with a generation energy determined by the atomic structure of the target metal. When the continuous spectrum is used, tungsten may mainly be used. On the other hand, when the line spectrum is used, appropriate one of copper, molybdenum, cobalt, chromium, iron, silver, etc., may be selected depending on desired X-ray energy.

Since the mammographic image P_{org} has to present a diseased tissue, which has a very small difference in X-ray absorption amount from that of normal tissues, with high contrast, low energy X-ray of around 15-25 keV is used for imaging. In order to selectively extract the necessary X-ray in this region, it is better to use not only the continuous X-ray but also the characteristic X-ray. As the target T of the X-ray tube Xt for mammography, molybdenum (Mo) is often used. As the radiation window W for mammographic imaging, berylium, which has low X-ray absorption, may be used.

Radiation quality and dose of the X-ray generated by causing the filament F to emit thermal electrons E and the electrons E to collide against the target T vary depending on the distance over which the X-ray has transmitted through the target T. Namely, the dose of the X-ray B irradiating the filament F side is higher (higher dose) than that of the X-ray A irradiating the target T side, and the radiation quality of the X-ray B is softer (lower energy) than that of the X-ray A (see FIG. 4). This phenomenon is called the heel effect, and in particular, is more markedly observed with a soft X-ray tube Xt using, for example, molybdenum.

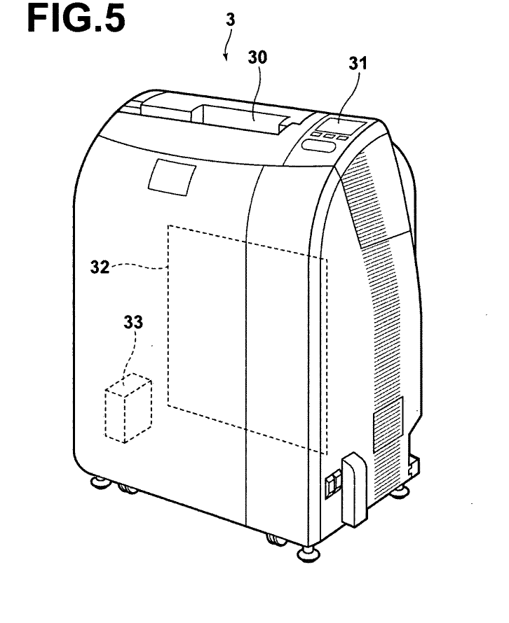

FIG. 5 shows one example of the image reading device 3 in FIG. 1. The image reading device 3 includes: a cassette insertion section 30, into which the cassette 241 containing the imaging plate IP is inserted; a reading manipulation unit 31, which allows the user to input an instruction to read, etc.; an image reading section 32, which reads the image from the imaging plate IP; and a reading control unit 33, which controls the individual mechanisms.

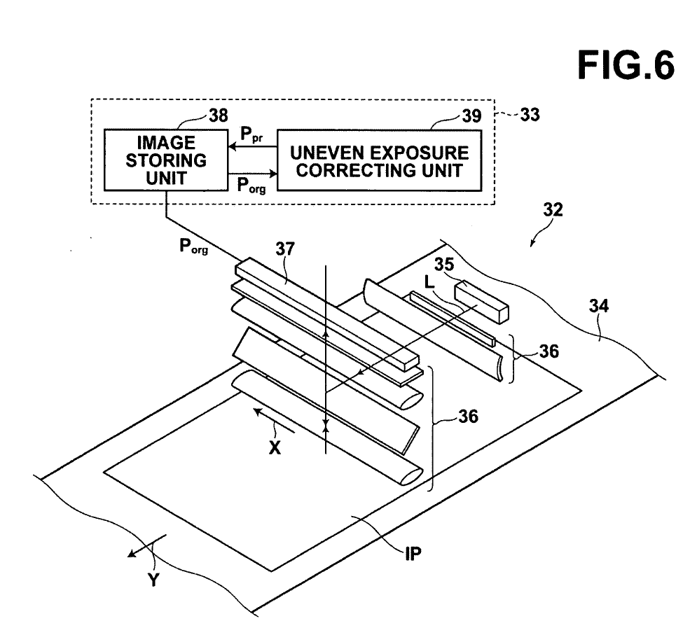

The reading control unit 33 includes a CPU (not shown) and memories, such as a ROM storing the control program and a RAM, and also includes an image storing unit 38 (see FIG. 6), such as a hard disk.

After the cassette 241 containing the imaging plate IP has been inserted into the cassette insertion section 30 and the instruction to read has been inputted via the reading manipulation unit 31, the cover of the cassette 241 is opened and the imaging plate IP in the cassette 241 is sent via a conveying mechanism (not shown) to the image reading section 32.

FIG. 6 is a perspective view of the image reading section 32. Although a one-dimensional line scanner-type image reading device is shown as an example in FIG. 6, the image reading device may be a known point scanner-type device or a two-dimensional detector-type device.

The image reading section 32 shown in FIG. 6 includes: a scanning belt 34, which conveys the imaging plate IP having the X-ray image information stored or recorded thereon in the direction of arrow Y; an excitation light source 35, which emits linear excitation light L; an optical system 36, which directs the excitation light L emitted from the excitation light source 35 toward the imaging plate IP; and a photoelectric conversion means 37 including a number of photoelectric conversion devices for photoelectrically converting the photostimulated luminescence emitted from the imaging plate IP.

The scanning belt 34 moves in the direction of arrow Y so that the imaging plate IP placed on the scanning belt 34 is conveyed in the direction of arrow Y. Synchronously with this conveyance, the linear excitation light L is emitted from the excitation light source 35, and the linear excitation light L transmitted through the optical system 36 and extending along the direction of arrow X illuminates the surface of the imaging plate IP. Further, the individual photoelectric conversion devices of the photoelectric conversion means 37 photoelectrically convert the received photostimulated luminescence, thereby reading the X-ray information stored on the imaging plate IP as an X-ray image (mammographic image) P_{org}.

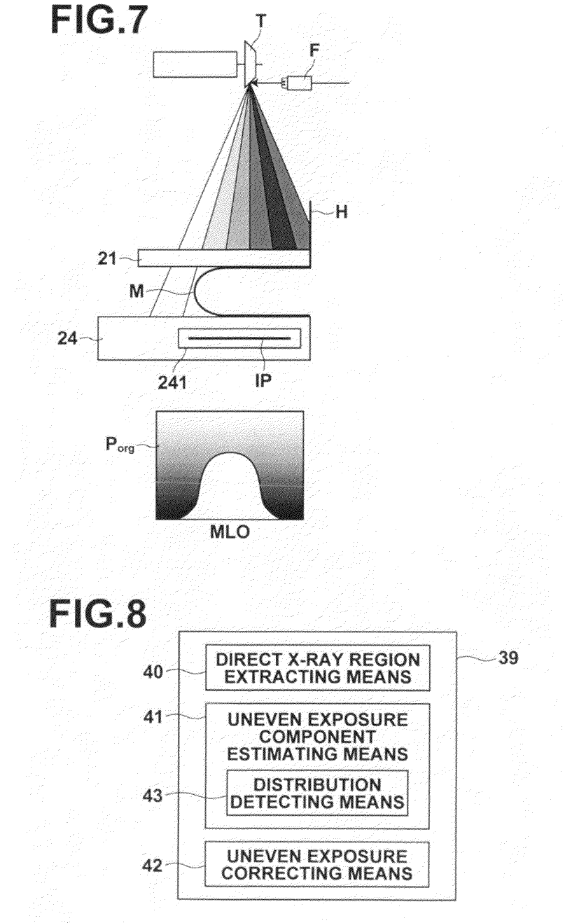

As shown in FIG. 7, the exposure dose of the mammographic image P_{org} gradually increases in the direction from the anode T to the cathode F of the X-ray tube Xt due to the above-described heel effect, and thus the mammographic image P_{org} has pixel values that relatively decrease in the direction from the anode T to the cathode F.

The reading control unit 33 receives the mammographic image P_{org} obtained through the photoelectric conversion by the photoelectric conversion means 37, and stores the mammographic image P_{org} in the image storing unit 38. Further, the reading control unit 33 executes an uneven exposure correction program to function as an uneven exposure correcting unit (a device for correcting for uneven exposure) 39, and generates a mammographic image Pₚᵣ, which is an image obtained by correcting the mammographic image P_{org} for the uneven exposure. It should be noted that the uneven exposure correction program may be installed in the reading control unit 33 from a recording medium, such as a CD-ROM, or may be downloaded from a server connected via a network, such as the Internet, before being installed. The installed program is stored in the ROM and/or RAM of the reading control unit 33.

As shown in FIG. 8, the uneven exposure correcting unit 39 includes a direct X-ray region extracting means 40, an uneven exposure component estimating means 41, and an uneven exposure correcting means 42.

The direct X-ray region extracting means 40 extracts a direct X-ray region from the X-ray image formed by the X-ray applied to the breast. The direct X-ray region corresponds to a region of the imaging plate IP which has directly been exposed to the X-ray.

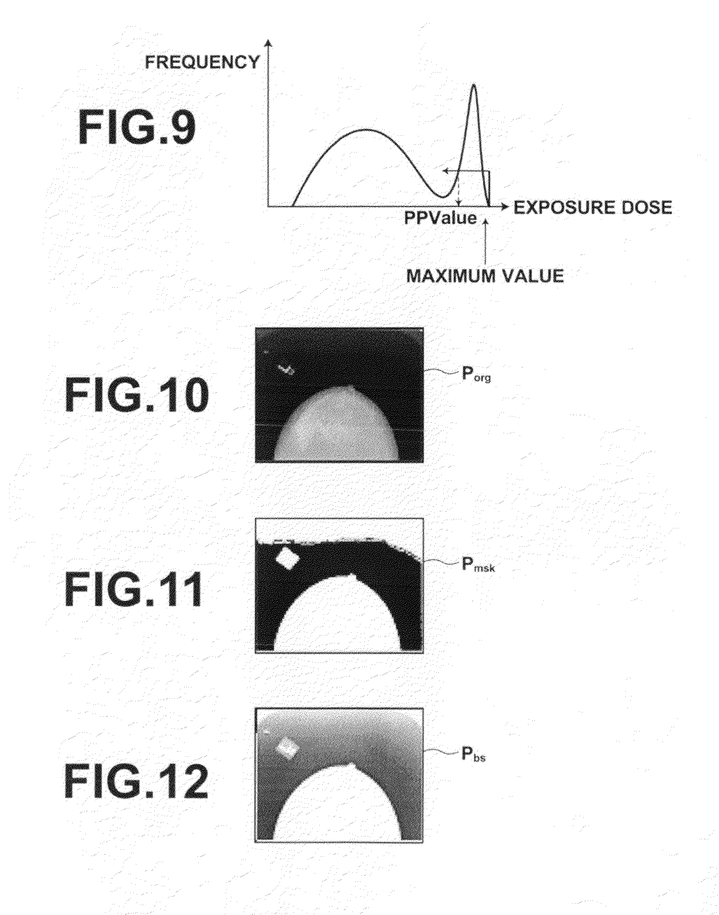

Specifically, since there is a clear difference in exposure dose (pixel values on the mammographic image) between the direct X-ray region and the breast region on the mammographic image P_{org}, the direct X-ray region can be separated from the breast region using a certain value as a threshold. FIG. 9 shows a typical histogram of exposure dose appearing on the mammographic image P_{org}, where the mountain shape on the right having the larger exposure dose corresponds to data of the direct X-ray region, and the mountain shape on the left corresponds to data of the breast region. It is considered that an appropriate exposure dose threshold used for separating the direct X-ray region from the mammographic image P_{org} is a value around the foot of the mountain shape on the right. The threshold for separating the direct X-ray region from the mammographic image P_{org} may be determined, for example, by searching through the histogram from the maximum value toward the lower values of the X-ray exposure dose, and finding an exposure dose (pixel value) of a pixel which is at a position corresponding to about 20% of the total number of pixels of the image from the maximum value to use the value of the pixel as the threshold. This threshold corresponds to the Pixel Padding Value of the IHE standard.

Binarizing the original mammographic image P_{org}, such as one shown in FIG. 10, using the above-described threshold, the image is roughly separated into the breast region and the direct X-ray region, as shown in FIG. 11. The white area at the lower part of the binarized image corresponds to the breast region, and the black area (hereinafter, this area is referred to as an initial mask Pₘₛₖ) corresponds to the direct X-ray region. Although the white area around the upper end of the binarized image is actually the direct X-ray region, the area has low exposure dose due to the heel effect and therefore has not been extracted as the direct X-ray region.

With the initial mask Pₘₛₖ, only the region directly exposed to the X-ray is extracted. Therefore, the area of the original mammographic image P_{org} corresponding to the initial mask Pₘₛₖ is extracted as the direct X-ray region (see FIG. 12. FIG. 12 shows a density-adjusted image P_{bs} to provide better understanding of gradation at the direct X-ray region of the original mammographic image P_{org}).

The white areas of the binarized image are the breast region and a part of the direct X-ray region. Since the breast region can correctly be identified based on the imaging direction of the breast, the orientation of the image, the shape of the breast region, the position of a marker placed during imaging (the rectangular region appearing on the image), etc., a region from which the breast region has been removed may be extracted as the direct X-ray region.

The uneven exposure component estimating means 41 further includes a distribution detecting means 43, which detects a pixel value distribution of pixels in the direct X-ray region.

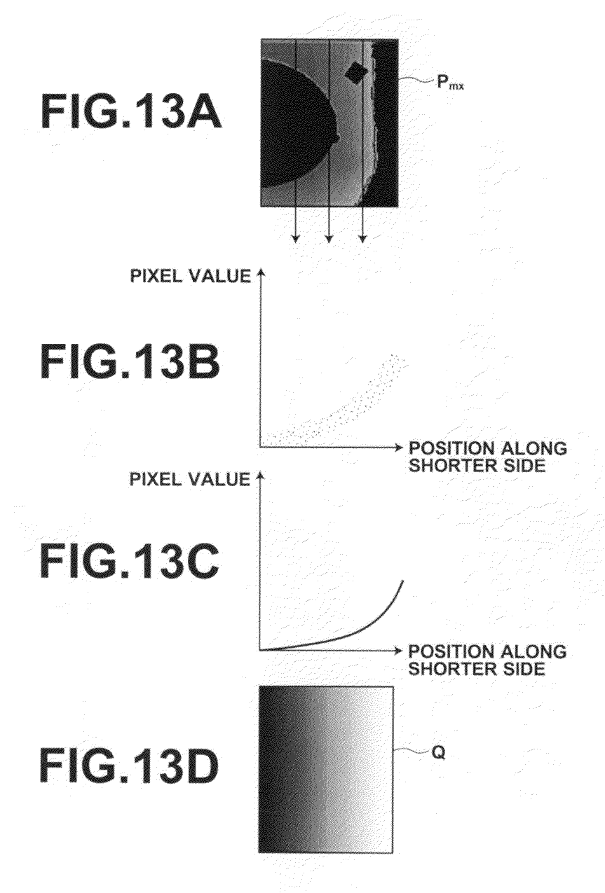

The distribution detecting means 43 detects a pixel value distribution in the direct X-ray region in a direction in which the heel effect is observed (i.e., in the direction that connects the anode T and the cathode F of the X-ray tube Xt). Specifically, in the direct X-ray region of the mammographic image P_{org} obtained by imaging the breast, the pixel values change along the shorter side direction of the image, such that the pixel value is larger (i.e., the exposure dose is smaller) at a position at a larger distance from the chest wall H (see FIG. 12). Therefore, the distribution detecting means 43 sums up, for each position in the shorter side direction, pixel values of pixels along a straight line in the longer side direction in the area of the mammographic image P_{org} within the initial mask Pₘₛₖ (see the gray region in an image Pₘₓ shown in FIG. 13A. Note that the density of the image Pₘₛ has been adjusted similarly to the image P_{bs} to provide better understanding). FIG. 13B is a graph showing the thus obtained pixel value distribution at the individual positions along the shorter side direction. As can be seen from this graph, the larger the distance from the chest wall H (in the direction from the anode to the cathode), the larger the pixel value.

The uneven exposure component estimating means 41 estimates the uneven exposure component at the individual positions in the direct X-ray region from the pixel value distribution in the direct X-ray region detected by the distribution detecting means 43. As can be seen from the graph shown in FIG. 13B, change of the pixel values corresponding to the uneven exposure component in the shorter side direction is nearly a quadratic function. Therefore, the change of the uneven exposure component is approximated with a quadratic function, as shown in FIG. 13C. The coefficient of the quadratic function is determined from the points on the graph shown in FIG. 13B using the least square method. Alternatively, a multinomial other than quadratic function may be used to represent average change of the pixel values along the shorter side direction. It should be noted that the uneven exposure component in the part of the direct X-ray region at the upper end portion of the Mammographic image P_{org}, which is outside the initial mask Pₘₛₖ (the black region at the right end of the image Pₘₓ shown in FIG. 13A), can be found through extrapolation using the above-obtained quadratic function.

The uneven exposure correcting means 42 removes the uneven exposure component from the original mammographic image P_{org}. If the mammographic image P_{org} is an image obtained by imaging in the MLO direction, the uneven exposure component is observed along the shorter side direction. Therefore, a grayscale image Q (see FIG. 13D) is generated by changing the pixel values of the pixels along the shorter side direction according to the quadratic function obtained by the uneven exposure component estimating means 41, and the grayscale image Q is subtracted from the original mammographic image P_{org}, thereby generating the corrected mammographic image Pₚᵣ.

The image interpretation device 5 is connected to the image reading device 3 via a network (not shown), or the like, and has a function of reading a mammographic image P from the image reading device 3 and displays the image on a display device. The image interpretation device 5 may include a high definition display device, such as a high definition CRT, for image interpretation of the mammographic image P by an image interpreter, such as a doctor.

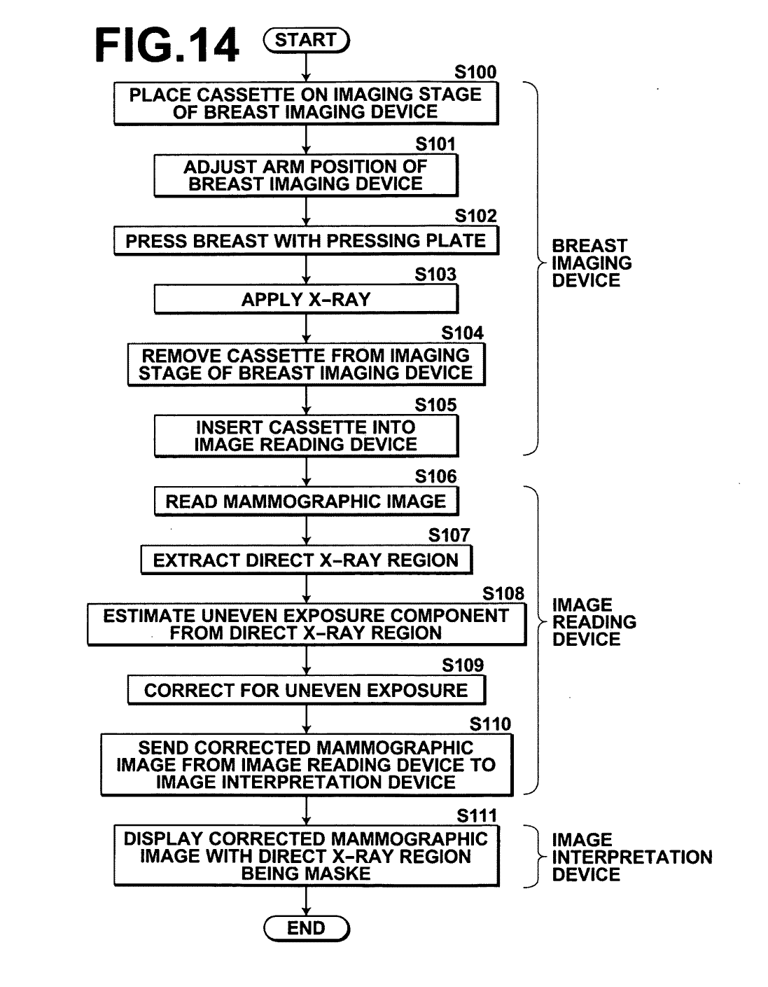

Next, a flow of a process carried out by the X-ray image reading system for removing the uneven exposure component from the imaged mammographic image is described with reference to the flow chart shown in FIG. 14.

First, to image the breast M, the cassette 241 having the imaging plate IP set therein is placed in the imaging stage 24 of the breast imaging device 2 (S100). As the patient stands by the breast imaging device 2, the operator inputs, via the imaging manipulation unit 28, such as a control panel, a height of the arm 25 depending on the body height of the patient and a rotation angle for the arm 25 depending on the size and shape of the breast M, and the arm moving unit 29 adjusts the height and angle of the arm 25 according to the inputted height and rotation angle. If the imaging is to be carried out in the MLO direction, the imaging stage 24 is inclined from the horizontal direction by an angle ranging from 45° to 80° so that the imaging stage 24 is positioned in parallel to the pectoral muscle of the patient. If the imaging is to be carried out in the CC direction, the imaging stage 24 is kept in the horizontal direction and the height of the imaging stage 24 is adjusted (S101). Because of the shape and thickness of the breast M, if the breast is imaged in the natural state, a tumor in the breast may not be captured due to the presence of mammary gland, fat, blood vessel, etc. Therefore, during mammographic imaging, the breast M is sandwiched between the pressing plate 21 and the imaging stage 24 to evenly spread the breast, so that even a shadow of a small lump can clearly be captured in the image with a small amount of X-ray. When the height and inclination of the imaging stage 24 are optimally adjusted for imaging, the breast M is pressed against the imaging stage 24 with the pressing plate 21 (S102).

The operator inputs instructions via the imaging manipulation unit 28, such as a control panel or a foot switch, to gradually press the breast M, with checking the state of the pressed breast M, and the pressing plate 21 is gradually moved down. When the pressing operation has been completed, imaging of the breast M is started, and the X-ray is applied from the X-ray irradiation unit 22 in the radiation source housing 23 (S103).

When the imaging has been completed, the cassette 241 is removed from the imaging stage 24 (S104), and is inserted into the cassette insertion section 30 of the image reading device 3 (S105). When the operator instructs to start reading via the reading manipulation unit 31, the imaging plate IP in the cassette 241 is conveyed to the image reading section 32, where the mammographic image P_{org} is read from the imaging plate IP. The thus read mammographic image P_{org} is once stored in the image storing unit 38 (S106).

Then, the direct X-ray region extracting means 40 extracts the direct X-ray region from the mammographic image P_{org} (S107). Subsequently, the uneven exposure component estimating means 41 estimates the uneven exposure component from the pixel values of pixels at individual positions in the direct X-ray region (S108). The uneven exposure correcting means 42 generates the grayscale image Q, which corresponds to the uneven exposure component estimated by the uneven exposure component estimating means 41, and subtracts the grayscale image Q from the original mammographic image P_{org}, thereby achieving correction for the uneven exposure. Then the corrected mammographic image Pₚᵣ is stored in the image storing unit 38 (S109).

When a request to send the mammographic image P is sent from the image interpretation device 5 to the image reading device 3, the image reading device 3 sends the mammographic image Pₚᵣ according to the DICOM format (S110). At this time, the threshold found by the direct X-ray region extracting means 40 is sent as the Pixel Padding Value of the IHE standard, together with the mammographic image Pₚᵣ, to the image interpretation device 5.

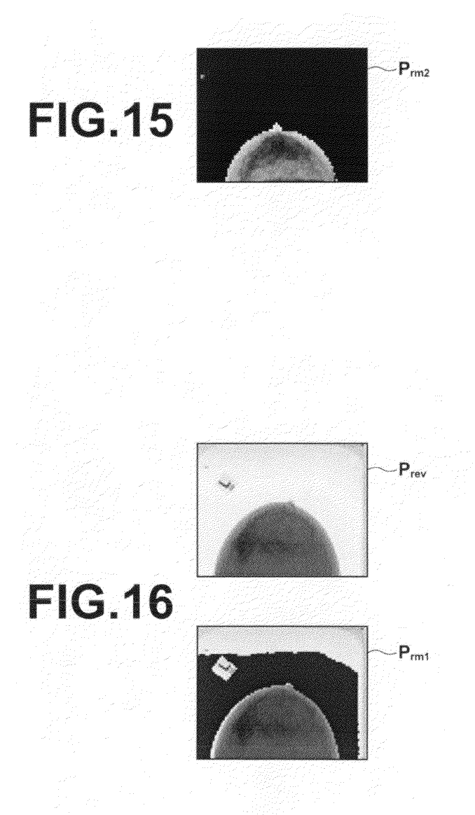

In the image interpretation device 5, when the mammographic image Pₚᵣ is displayed with the inverted density, the entire direct X-ray region is masked by using the Pixel Padding Value as the threshold to provide glare prevention (S111). FIG. 15 shows an image Pᵣₘ₂, which is one example of the density-inverted image in this embodiment with the entire direct X-ray region being appropriately masked. It should be noted that, although the direct X-ray region can be masked using a certain threshold, such as the Pixel Padding Value, as described above, the threshold for masking may be varied depending on conditions of the image processing applied to the mammographic image P_{org}, since, in practice, the mammographic image P_{org} is subjected to various types of image processing, such as dynamic range compression and gray level conversion, before being masked and displayed on the image interpretation device 5.

As described in detail above, according to the embodiment of the invention, the uneven exposure component estimating means 41 estimates the uneven exposure component based on the pixel value distribution in the direction in which the heel effect is observed (i.e., in the direction that connects the anode and the cathode of the X-ray tube Xt) in the direct X-ray region extracted by the direct X-ray region extracting means 40, and the uneven exposure correcting means 42 corrects for the uneven exposure of the image. By estimating the uneven exposure component using only the direct X-ray region, where the contribution of the uneven exposure component is large, highly accurate estimation of the uneven exposure component can be achieved. Further, by estimating the uneven exposure component using the direct X-ray region of each X-ray image to be processed, the correction for the uneven exposure component can flexibly be carried out for wide variation of the uneven exposure among X-ray images due to difference of the X-ray source and fluctuation of the tube voltage, thereby appropriately minimizing the uneven exposure component in the X-ray images.

Further, when a density-inverted mammographic image is displayed on the image interpretation device 5, the direct X-ray region of the mammographic image can accurately be masked to provide glare prevention.

Although the estimation of the uneven exposure component is achieved in the above-described embodiment by approximating the distribution of the pixel values at individual positions in the direct X-ray region along the shorter side direction of the original mammographic image P_{org} with a quadratic function, the estimation of the uneven exposure component may be achieved using two-dimensional correction (fitting to a curved surface) in a coordinate space with plotting the pixel values in the direct X-ray region in the mammographic image P_{org} along the z-axis and plotting the two-dimensional positions of the pixels along the x- and y-axes.

In the above-described embodiment, the uneven exposure component is removed from the entire original mammographic image P_{org}. By removing the uneven exposure component also from the breast region, which is the subject, the pixel values in the breast region are brought closer to values that correspond to the thickness of and structures in the breast, and thus image quality improvement is provided. On the other hand, if only glare prevention of a density-inverted image displayed on the image interpretation device 5 is desired, the uneven exposure component may be removed only from regions other than the breast region in the mammographic image P_{org}.

It should be noted that, besides the above-described embodiment, various changes and modifications may be made to the system configuration, process flow, and the like, described in the embodiment without departing from the scope and spirit of the present invention, and such changes and modifications are intended to be encompassed by the technical scope of the invention. The above-described embodiment is presented only by way of example, and the explanation given above should not be construed to limit the technical scope of the invention.

For example, although the above embodiment is specifically described in conjunction with mammographic images, the present invention is also applicable to other X-ray images which are obtained by imaging other parts of a human body or animal body.

Further, although the above embodiment is described about the case where the device for correcting for uneven exposure of the invention is implemented in the image reading device of the X-ray image reading system which uses storage phosphor sheets, the hardware implementing the device of invention is not limited to the image reading device, and the device of the invention may be implemented, for example, in the image interpretation device. Moreover, the system implementing the device of invention is not limited to the system using storage phosphor sheets, and the device of the invention may be implemented in various systems in which the uneven exposure component of the applied X-ray may be recorded as image information, such as a system that detects X-ray using a flat-panel detector (FPD)

### EFFECT OF THE INVENTION

In the present invention, at least a portion of a region without the subject contained therein is extracted from an X-ray image as a direct X-ray region, and an uneven exposure component at individual pixels of the original X-ray image is estimated based on a relationship between positions and pixel values of at least some of pixels in the extracted direct X-ray region. By estimating the uneven exposure component using only the direct X-ray region, where the contribution of the uneven exposure component is large, highly accurate estimation of the uneven exposure component can be achieved. Further, by estimating the uneven exposure component using the direct X-ray region in each X-ray image to be processed, the correction for the uneven exposure can flexibly be carried out for wide variation of the uneven exposure among images due to difference of the X-ray source and fluctuation of the tube voltage.

According to the invention, the thus estimated uneven exposure component is removed from the original X-ray image, thereby allowing appropriate minimization of the uneven exposure component in each X-ray image.

For image interpretation of a mammographic image obtained by imaging the breast as the subject, it is necessary to detect a small difference in density of the image, such as detecting a shadow of a tumor mass in the mammary gland region, and it is therefore preferred that a small difference in amount of X-ray absorption by the subject (exposure dose) during imaging is reflected in the image. Since a low energy X-ray is used in the mammographic imaging, the uneven exposure component due to the heel effect is notably observed in the image. By applying the uneven exposure correction of the invention to an X-ray image of the breast, the uneven exposure component due to the heel effect is appropriately minimized even in the breast region in the image, and this is very effective to improve accuracy of the image interpretation.

In addition, by approximating the uneven exposure component due to the heel effect with a quadratic function, the uneven exposure component can be expressed with higher accuracy and fewer variables, and this is effective both in processing accuracy and processing efficiency.

What is claimed is:

1. A device for correcting for uneven exposure, the device comprising:
direct X-ray region extracting means for extracting a direct X-ray region from an X-ray image formed by an X-ray applied from an X-ray tube to a subject, the direct X-ray region being at least a portion of a region without the subject contained therein;
uneven exposure component estimating means for estimating an uneven exposure component at individual pixels of the X-ray image based on a relationship between positions and pixel values of at least some of pixels in the direct X-ray region; and
uneven exposure correcting means for removing the uneven exposure component from at least the region without the subject contained therein of the X-ray image.

2. The device for correcting for uneven exposure as claimed in claim 1, wherein the uneven exposure component estimating means comprises:
distribution detecting means for detecting a pixel value distribution of pixels in the direct X-ray region in a direction on the X-ray image corresponding to a direction connecting an anode and a cathode of the X-ray tube; and
means for estimating the uneven exposure component at individual pixels of the X-ray image by estimating the uneven exposure component at individual positions along the direction on the X-ray image based on the detected pixel value distribution.

3. The device for correcting for uneven exposure as claimed in claim 2, wherein the uneven exposure component comprises an uneven exposure component induced by heel effect of X-ray.

4. The device for correcting for uneven exposure as claimed in claim 3, wherein the uneven exposure component estimating means estimates the uneven exposure component by approximating the pixel value distribution with a function expressed as a multinomial.

5. The device for correcting for uneven exposure as claimed in claim 4, wherein the function is a quadratic function.

6. The device for correcting for uneven exposure as claimed in claim 1, wherein the direct X-ray region extracting means extracts the direct X-ray region by extracting a region in the X-ray image having an exposure dose larger than a value obtained by a predetermined method.

7. The device for correcting for uneven exposure as claimed in claim 1, wherein the uneven exposure correcting means removes the uneven exposure component from the entire X-ray image.

8. The device for correcting for uneven exposure as claimed in claim 1, wherein the uneven exposure correcting means removes the uneven exposure component only from the region without the subject contained therein in the X-ray image.

9. The device for correcting for uneven exposure as claimed in claim 1, wherein the subject is breast.

10. A method for correcting for uneven exposure, the method comprising the steps of:
extracting a direct X-ray region from an X-ray image formed by an X-ray applied from an X-ray tube to a subject, the direct X-ray region being at least a portion of a region without the subject contained therein;
estimating an uneven exposure component at individual pixels of the X-ray image based on a relationship between positions and pixel values of at least some of pixels in the direct X-ray region; and
removing the uneven exposure component from at least the region without the subject contained therein of the X-ray image.

11. A computer-readable recording medium containing a program for correcting for uneven exposure, the program causing a computer to carry out the operations of:
extracting a direct X-ray region from an X-ray image formed by an X-ray applied from an X-ray tube to a subject, the direct X-ray region being at least a portion of a region without the subject contained therein;
estimating an uneven exposure component at individual pixels of the X-ray image based on a relationship between positions and pixel values of at least some of pixels in the direct X-ray region; and
removing the uneven exposure component from at least the region without the subject contained therein of the X-ray image.
